(19) United States
(12) Patent Application Publication
(10) Pub. No.: US 2002/0146111 A1
(43) Pub. Date: Oct. 10, 2002

(54) Method and telephone device for exchanging calls from plural areas with a single exchange

(75) Inventor: Mitsuru Hayashi, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/095,067

(22) Filed: Mar. 12, 2002

(30) Foreign Application Priority Data
Mar. 12, 2001 (JP) 69216/2001

(51) Int. Cl. H04M 1/00; H04M 3/00

(52) U.S. Cl. 379/355.08; 379/352

(57) ABSTRACT

When a caller dials a telephone number with a telephone device assigned to a caller area code, the telephone device stores the telephone number to analyze it. According to the analysis, the telephone device adds the caller area code to the top of the dialed telephone number if the call is addressed to a telephone device in the area assigned to the caller area code, and the dialed telephone number does not include the caller area code.

### BACKGROUND OF THE INVENTION

This invention relates to a telephone device and a method of connecting two telephone devices with each other via an exchange. In particular, this invention relates to a telephone network in which a single exchange replaces plural exchanges each of that is assigned to a different area code.

Generally, in a public telephone network, an exchange is placed at each area to which an area code is assigned. In recent years, the performance of an exchange has been improved. Therefore, it would be unreasonable and too expensive to establish one exchange at one area, considering the performance of exchanges. Taking the improvement of the performance into account, it is preferable that plural exchanges are replaced by a single exchange. In this case, however, following problems appear.

(1) Exchanges for originally accommodating a single area code may be remodeled to accommodate plural are codes. The remodeling requires large extensions of data memories in the exchanges and modifications to software performed on the exchanges.

(2) It is assumed that telephone devices in plural areas make calls via the exchange to an authorized party. The authorized party means, for example, a police station, an emergency medical center, or a firehouse, and often has plural reception centers each of that is located in each area. When the authorized party has reception centers in every area, it may be preferable that each of the calls should be connected to the reception center in the same area. However, if plural exchanges have been replaced a single exchange conventionally, then all of the calls may be connected to a single representative reception center independently of the areas in which the calls are sent.

(3) Some service providers provide plural services each of which is assigned to a telephone number. Their customers select one of the telephone numbers in order to select one of the services. On the other hand, some service providers provide plural services all of which are assigned to a single telephone number, and select one of the services for a customer in accordance with attributes of the customer. Conventionally, the latter service providers may not be able to provide the services.

According to the conventional replacement of exchanges, in order to manage plural areas each of that is assigned to a different area code by a single exchange, the exchange requires enormous capacity for data memory, and in addition, revision of software for operating the exchange. Further, subscribers cannot call an authorized party when a representative reception center is interrupted, even if a local reception center of the authorized party is not interrupted. And further, service providers may be unable to provide one of plural services assigned to a single telephone number with reference to attribute of the customer.

In order to meet the demand of the law, description will be made about a Japanese patent unexamined publication number H 11-113035, namely 113035/1999 (hereinafter referred to as related publication), which relates to the present invention.

As shown in FIG. 1, the telephone network of the related publication includes two areas TCA1 and TCA2, whose area codes are “045” and “044” respectively, and subscriber lines in the both areas are accommodated by a single exchange EX. The area TCA1 includes local areas LA11, LA12 and LA13, whose local area codes are “111”, “112” and “113” respectively. The area TCA2 includes local areas LA21, LA22 and LA23, whose local area codes are “221”, “222” and “223” respectively.

An integrated area UAR includes the areas TCA1 and TCA2. The exchange EX accommodates the integrated area UAR. In the area TCA1, a reception center SNR1 is placed. In the area TCA2, a reception center SNR2 is placed. In the integrated area UAR, a representative reception center SNR is placed. The reception centers SNR1 and SNR2 and the representative reception center SNR accept emergency calls to a predetermined party, e.g. the police.

Originally, as shown in FIG. 2a, the area TCA1 was accommodated by an exchange TEX1. The area TCA2 was accommodated by an exchange TEX2. After that, as shown in FIG. 2b, the exchange EX has replaced the exchanges TEX1 and TEX2 and accommodates the integrated area UAR. It is noted that the top two digits “04” of the area code “045” are the same as the top two digits of the area code “044”.

After the replacement, the top two digits of telephone numbers “045-111-XXXX”, “045-112-XXXX” and “045-113-XXXX” are translated to an inner area code “04”. The middle four digits “5-111”, “5-112” and “5-113” of the telephone numbers are translated to inner local area codes “5111”, “5112” and “5113” respectively. In the telephone numbers, an X represents a digit.

Similarly, the top two digits of telephone numbers “044-221-XXXX”, “044-222-XXXX” and “044-223-XXXX” are translated to the inner are code “04”. The middle four digits “4-221”, “4-222” and “4-223” of the telephone numbers are translated to inner local area codes “4221”,“4222” and “4223” respectively.

According to the translation mentioned above, a translation table (not shown) is prepared and stored in the exchange EX. With reference to the translation table, the exchange EX establishes connections to the telephone devices in the integrated area UAR, namely in the areas TCA1 and TCA2.

It is noted that, according to the technique of the related publication, in order to split a single inner area code from plural area codes to manage the area codes by a single exchange, top digits of the plural area codes has to correspond with each other. The rest digits of the area codes are added to local area codes to create inner local area codes. A translation table is generated based on the relationship between area codes, local area codes, inner area codes and inner local area codes. The exchange EX connects calls with reference to the translation table.

A telephone device 210 used in the telephone network is described below with reference to FIG. 3. The telephone device 210 includes a communication circuit 221, a dial pulse/push button (DP/PB) signal generating circuit 222, a dial pad 223, a ringer circuit 231, an electric bell 232 and a handset 241.

First, description will be made about the telephone device 210 receiving a call. The communication circuit 221 is connected to a subscriber line 211 from the exchange EX. The ringer circuit 231 receives a ringer signal via the subscriber line 211 from the exchange EX. When the ringer circuit 231 detects a ringer signal, the ringer circuit 231 transforms the ringer signal to voltage and sends the voltage to the electric bell 232. In response to the voltage, the electric bell 232 rings out to notify a subscriber of arrival of a call. If the subscriber could hear the ringing, then she/he would hook off the handset 241.

When the handset 241 is off-hooked, the communication circuit 221 creates a loop and notices via the subscriber line 211 the exchange EX that the subscriber hooks off the handset 241. In response to this, the exchange EX stops sending ring signals to the telephone device 210. When the ringer circuit 231 detects discontinuance of ring signals, the ringer circuit 231 stops making the electric bell 232 ring.

Next, description will be made about the telephone device 210 sending a call to another telephone device (designation telephone device). When the subscriber hooks off the handset 241, the communication circuit 221 creates a loop and notice the exchange EX that the handset 241 is off-hooked. When the exchange EX detects the off-hooking via the subscriber line 211, the exchange EX generates a dial tone and sends it to the telephone device 210. Then, the exchange EX stands by for receiving the telephone number of the designation telephone device (designation telephone number) from the telephone device 210.

When the communication circuit 221 receives the dial tone via the subscriber line 211 from the exchange EX, the communication circuit 221 sends the dial tone to the handset 241. The handset 241 sounds the dial tone by its speaker to the subscriber. Then, the subscriber dials the designation telephone number with the dial pad 223. The input designation telephone number is sent to the DP/PB signal generating circuit 222. The DP/PB signal generating circuit 222 transforms the telephone number to dial tone signals or push button signals and sends them to the communication circuit 221. After that, the communication circuit 221 sends the signals via the subscriber line 211 to the exchange EX.

The related technique mentioned above, however, requires changing numbering plans of telephone numbers in areas where a single exchange is to replace plural exchanges. In many areas, telephone networks and their numbering plans have already been established. Therefore, it is often difficult to change numbering plans. Consequently, the related technique is not available for all of areas.

### SUMMARY OF THE INVENTION

It can be an object of the present invention to replace plural exchanges with a single exchange without changing numbering plan of telephone numbers.

According to one aspect of this invention, a telephone device which is assigned to a caller telephone number, the caller telephone number comprising a caller area code is provided. The telephone device comprises; an input device for accepting a first telephone number; a storage device for storing the first telephone number; a controller circuit for judging whether the first telephone number stored in the storage device designates one of the telephone numbers grouped by the caller area code or not, and for adding the caller area code to the top of the first telephone number to generate a second telephone number when the first telephone number designates one of the telephone numbers grouped by the caller area code; and a signal generator circuit for generating a signal for transmitting the second telephone number to an exchange.

The controller circuit may count the number of digits of the first telephone number stored in the storage device. In this case, the controller circuit judges whether the first telephone number is one of predetermined telephone numbers or not, according to the counted number. The controller circuit outputs the first telephone number to the signal generator circuit when the first telephone number is one of the predetermined telephone numbers.

The controller circuit may judge whether the first telephone number stored in the storage device is one of predetermined telephone numbers or not, according to at least one top digit of the first telephone number. In this case, the controller circuit outputs the first telephone number to the signal generator circuit when the first telephone number is one of the predetermined telephone numbers.

The controller circuit may activate a timer when one digit is input from the storage device. In this case, the controller circuit judges whether the first telephone number stored in the storage device designates one of the telephone numbers grouped by the caller area code when the timer has clocked a predetermined time period before the next digit of the first telephone number is input from the storage device The controller circuit then adds the caller area code to the top of the first telephone number to generate a second telephone number when the first telephone number designates one of the telephone numbers grouped by the caller area code.

The controller circuit may count the number of digits of the first telephone number stored in the storage device. In this case, the controller circuit judges whether the first telephone number is one of predetermined telephone numbers or not, according to the counted number. Next, the controller circuit adds the caller area code to the top of the first telephone number to generate a second telephone number when the first telephone number is one of the predetermined telephone numbers. Then, the controller circuit outputs the second telephone number to the signal generator circuit.

According to another aspect of this invention, a method of exchanging a call from a telephone device which belongs to an area assigned to a caller area code is provided. The method comprises the steps of: inputting a first telephone number to the telephone device; storing whole of the first telephone number in the telephone device; judging whether the first telephone number includes the caller area code or not; adding the caller area code to the top of the first telephone number in order to generate a second telephone number according to the result of the judging step; and sending the second telephone number to an exchange,

The method may further comprise the steps of: counting the number of digits of the first telephone number stored at the storing step, judging whether the first telephone number is one of predetermined telephone numbers or not, according to the result of the counting step; and sending the first telephone number to the exchange, if the first telephone number is one of the predetermined telephone numbers.

The method may further comprising the steps of: counting the number of digits of the first telephone number stored at the storing step; judging whether the first telephone number is one of predetermined telephone numbers or not, according to the result of the counting step; and adding the caller area code to the top of the first telephone number in order to generate a second telephone number according to the result of the judging step; and sending the second telephone number to the exchange

It is assumed that a caller telephone number is “07-111-2222” and a receiver telephone number is “07-333-4444”. Both of the numbers include the same area code “07”, the caller would therefore dial “3334444” except the area code “07”. In this case, when the caller intends to call the receiver, the caller inputs “333-4444”.

First, the input number “333-4444” is composed of seven digits. Second, with reference to the top digit “3” of the input number “3334444”, the input number “333-4444” does not include an area code whose top digit is “0”. And finally, the input number “333-4444” is not one of predetermined authorized telephone numbers, such as “110” (emergency police telephone number in Japan) and “119” (medical emergency telephone number in Japan), Consequently, the input number “333-4444” can be recognized as one of general telephone numbers in the same area of the area code “07”.

Therefore, the caller telephone device adds the area code “07” to the input number “333-4444”, and sends the modified number “07-3334444” to the exchange As a result, the exchange can connect the call to the receiver with reference to the whole of the receiver telephone number “07-333-4444”, even if the caller did not input the area code “07”.

As mentioned above, the telephone device of the present invention distinguishes a dialed telephone number, next, if necessary, modifies the dialed telephone number, and then sends the dialed/modified telephone number to an exchange. The exchange can distinguish a call from an area to the same area from a call from an area to another area with reference to the dial/modified telephone number. Therefore, a single exchange can exchange calls from different areas. It is unnecessary to change numbering plan of telephone numbers and to remodel the exchange.

### BRIEF DESCRIPTION OF THE DRAWING

FIG. 1 shows a telephone network described in Japanese patent unexamined publication number H11-113035;

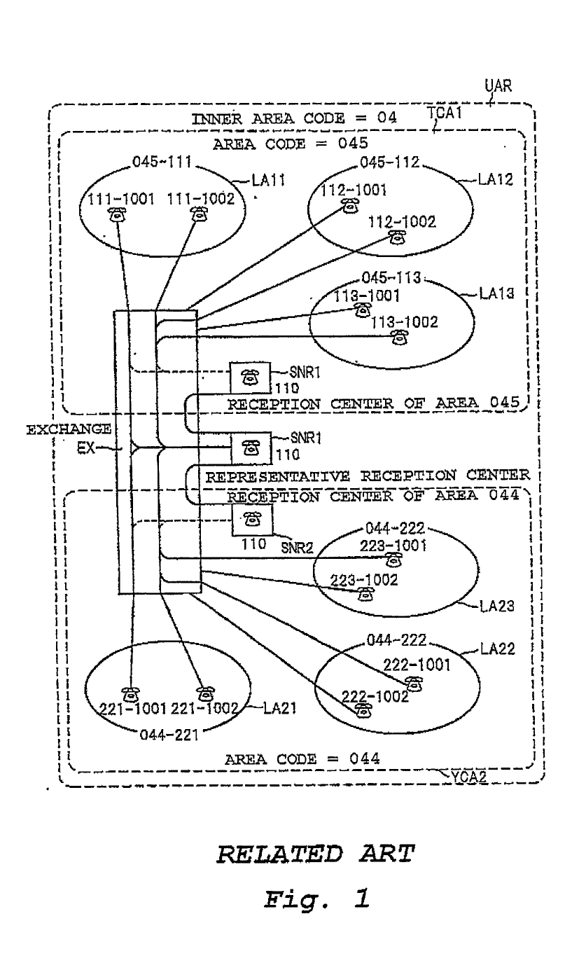

FIG. 2a shows the numbering plan of the telephone network before replacing exchanges TEX1 and TEX2 with the exchange EX and FIG. 2b shows the numbering plan of the telephone network after replacing exchanges TEX1 and TEX2 with the exchange EX;

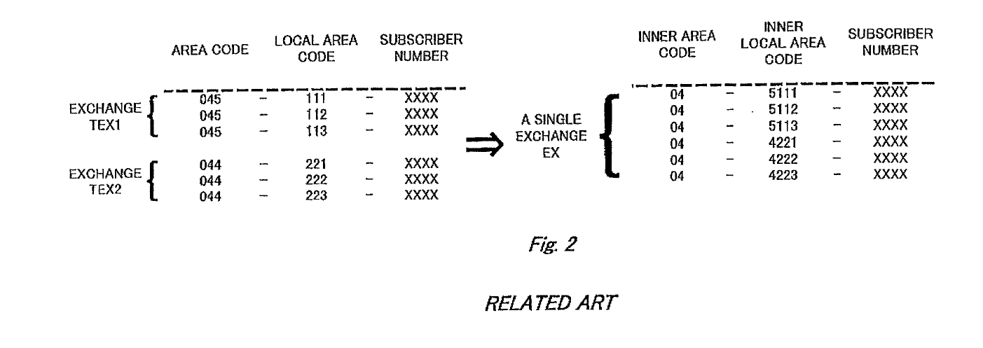

FIG. 3 shows a block diagram of a conventional telephone device used in the telephone network shown in FIG. 2;

FIG. 4 shows a telephone network of an embodiment of the present invention;

FIG. 5 shows a block diagram for use in describing the telephone device 201;

FIG. 6 shows a flowchart for describing the calling operation of the telephone device 201;

FIG. 7 shows a flowchart for describing the calling operation of the telephone device 201; and

FIG. 8 shows a flowchart for describing the exchange operation of the exchange 200.

### DESCRIPTION OF THE PREFERRED EMBODIMENTS

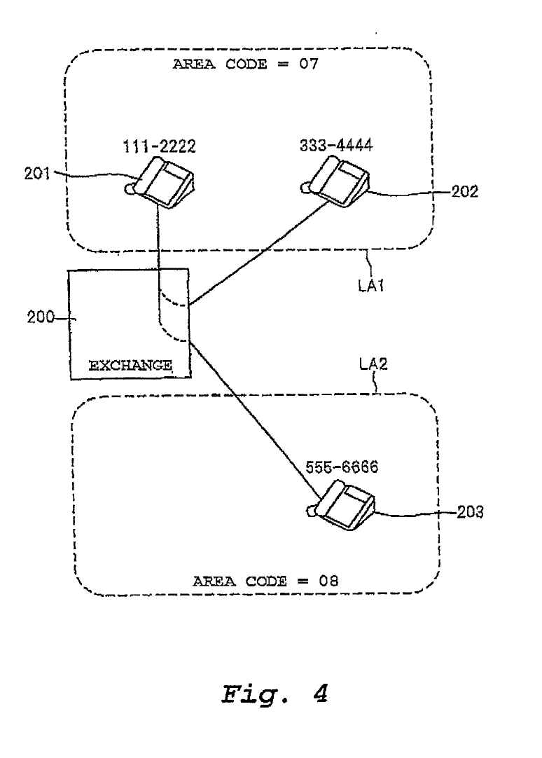

Description will be made about a telephone network of an embodiment of the present invention. As shown in FIG. 4, the telephone network includes an area LA1 assigned to an area code “07” and an area LA2 assigned to an area code “08”. In order to exchange the telephone terminals in both areas LA1 and LA2, an exchange 200 is established.

In the area LA1, there are telephone devices 201 and 202. The telephone device 201 is assigned to a telephone number “111-2222”. The telephone device 202 is assigned to a telephone number “333-4444”. In the area LA2, there is a telephone device 203, which is assigned to a telephone number “555-6666”.

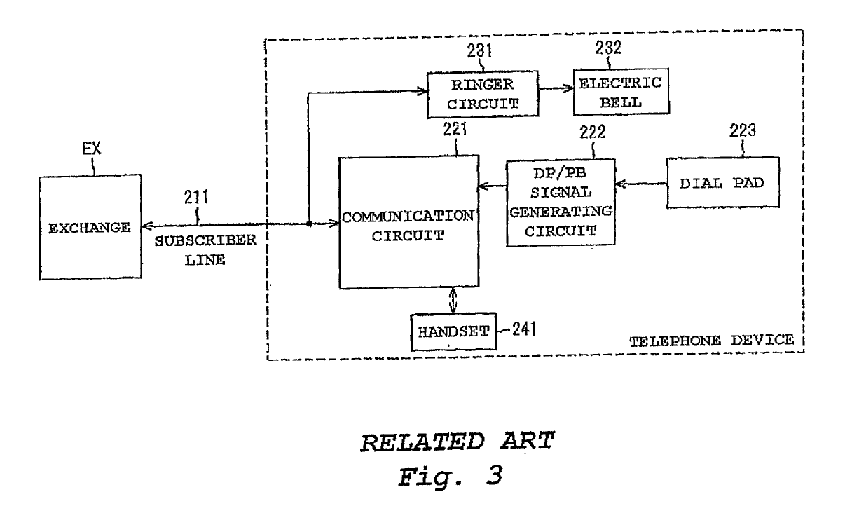

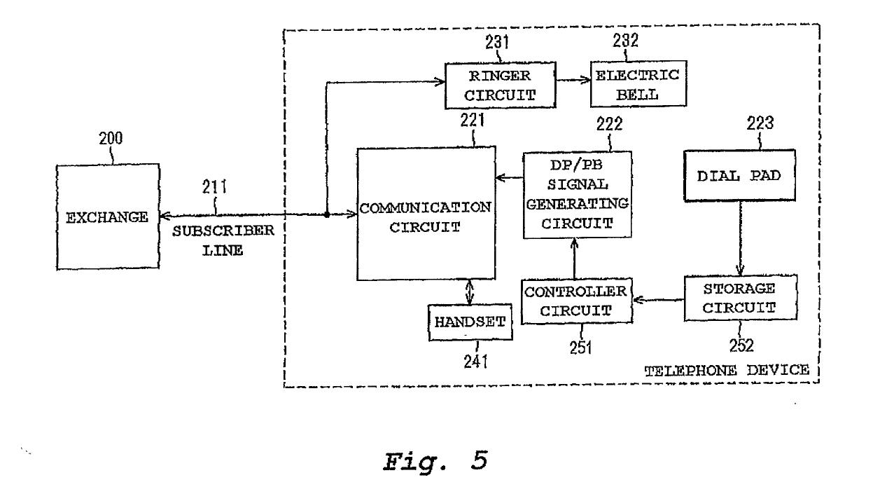

The telephone devices 201, 202 and 203 include the same components. On behalf of these three telephone devices, the telephone device 201 is described below with reference to FIG. 5. In FIG. 5, the components corresponding to ones shown in FIG. 3 are indicated by the same reference marks.

The telephone device 201 includes the communication circuit 221, the DP/PB signal generating circuit 222, the dial pad 223, the ringer circuit 231, the electric bell 232, the handset 241, and in addition, a controller circuit 251 and a storage circuit 252, The controller circuit 251 controls operation of the telephone device 201. The storage circuit 252 stores input from the dial pad 223 and sends it to the controller circuit 251.

Each time the user of the telephone device 201 inputs a digit with the dial pad 223, the storage circuit 252 receives and stores the digit, and then informs the controller circuit 251 of receiving the digit. In response to the information, the controller circuit 251 activates a software timer installed in the controller circuit 251. The software timer measures a predetermined time period. If the storage circuit 252 informs the controller circuit 251 of receiving the next digit before the time period has passed, then the controller circuit 251 stops the software timer. On the other hand, if the time period has passed before the storage circuit 252 is informed of receiving the next digit, then the controller circuit 251 reads all of the digits stored in the storage circuit 252 and counts the number of the digits.

The operation of the controller circuit 251 is described below in detail.

(1) Generally, authorized parties such as the police, emergency medical centers and firehouses have telephone numbers that are composed of the same number of digits. For example, in Japan, telephone numbers of authorized parties are composed of three digits: the emergency police telephone number is “110”; and the medical emergency call telephone number/the emergency firehouse call telephone number is “119”. Hereinafter it is assumed that telephone numbers of authorized parties are composed of three digits.

If an authorized party's number is dialed, then the controller circuit 251 outputs the number to the DP/PB signal generating circuit 222. The DP/PB signal generating circuit 222 instantly transforms the number to a DP signal or a PB signal, and outputs the signal to the communication circuit 221. The communication circuit 221 sends the signal via the subscriber line 211 to the exchange 200.

(2) Generally, the first digit of area codes, telephone numbers of cellular telephone devices and PHS (personal handyphone system) terminal devices are a specific number, namely an access code.

If the telephone number read from the storage circuit 252 includes the access code at the first digit, then the controller circuit 251 outputs the telephone number to the DP/PB signal generating circuit 222. The DP/PB signal generating circuit 222 transforms the number to a DP signal or a PB signal, and outputs the signal to the communication circuit 221. The communication circuit 221 sends the signal via the subscriber line 211 to the exchange 200.

For example, in Japan, the first digit of area codes, telephone numbers of cellular telephone devices and PHS (personal handyphone system) terminal devices are “0”. Therefore, if the first digit of a dialed telephone number is “0”, then the controller circuit 251 outputs the dialed telephone number to the DP/PB signal generating circuit 222.

(3) A telephone number is usually composed of an area code, a local area code and a subscriber number. When the user calls a subscriber in the same area, the user dials the local area code and the subscriber number of the subscriber's telephone number.

It is assumed that: (a) the number of digits of the dialed telephone number does not correspond to that of the authorized parties; (b) the first digit of the dialed telephone number does not corresponds to the access code; and (c) the number of the digits of the dialed telephone number corresponds to that of a local area code and a subscriber number in the area that the telephone device 201 belongs to.

In this case, the controller circuit 251 adds the area code of the telephone device 201, which includes the access code for indicating that the designation of the call is not one of the subscribers in the same area, to the top of the dialed telephone number. Then, the controller 251 outputs the added telephone number to the DP/PB signal generating circuit 222. The DP/PB signal generating circuit 222 transforms the added telephone number to a DP/PB signal and outputs it to the communication circuit 221. The communication circuit sends the signal via the subscriber line 211 to the exchange 200.

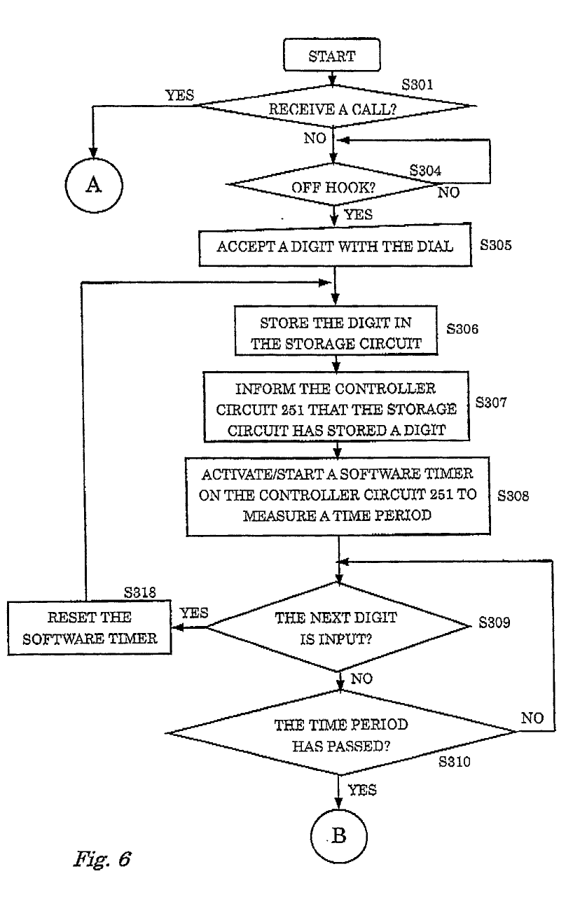

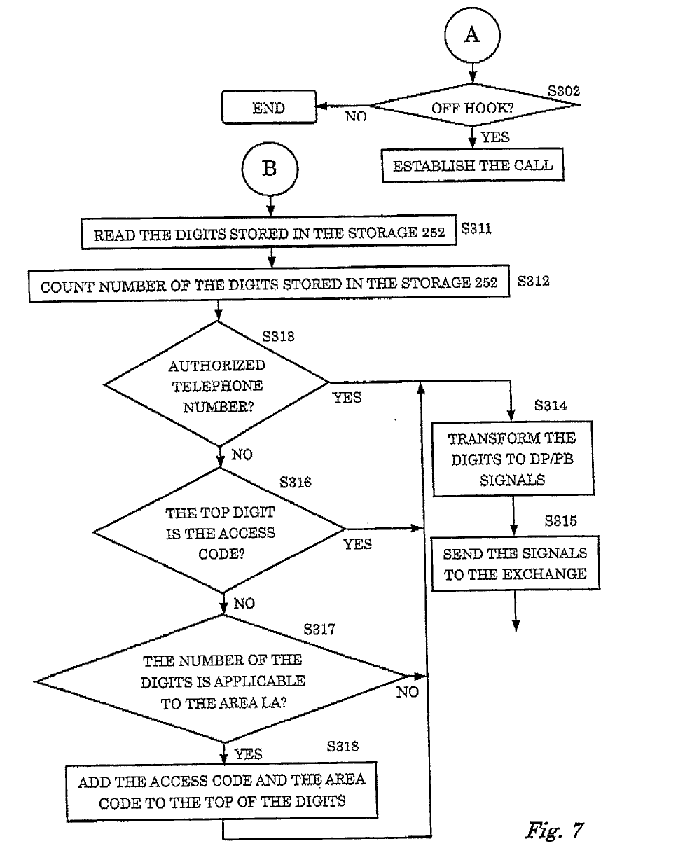

Turning to FIG. 6 and 7, description will be made about the exchanging operation in the telephone network. It is assumed that the user of the telephone device 201 is a caller, Namely, the caller telephone number is “07-111-2222”. It is noted that the telephone device 201 belongs to the area LA1 and the area code of the area LA1 is “07”.

When the telephone device 201 informs the exchange 200 that the handset 241 is hooked off, the exchange 200 sends a dial tone back to the telephone device 201 and stands by for receiving telephone number from the telephone number 201. In response to the dial tone from the exchange via the subscriber line 211, the communication circuit 221 sends the dial tone to the handset 241. The handset 241 plays the dial tone to the user.

In response to the dial tone, the user would dial a designation telephone number with the dial pad 223. The designation telephone number is sent to the storage circuit 252, The storage circuit 252 stores the designation telephone number.

The following operation depends on which area the designation telephone number belongs to.

(A) Calling From an Area to Another Area

It is assumed that the designation telephone number is “08-5556666”. In this case (A), a call is sent from the area LA1 to the different area LA2.

First, the user of the telephone device 201 hooks off the hand set 241 (S304) and dials the designation telephone number “08-555-6666” with the dial pad 223 ($305). Each digit of the designation telephone number is sequentially sent from the dial pad 223 to the storage circuit 252 and is stored in the storage circuit 252 (S306). Each time the storage circuit 252 receives a digit of the designation telephone number, the storage circuit 252 informs the controller circuit 251 of receiving the digit (S307).

Each time the controller circuit 251 receives the information, the controller circuit 251 activates a software timer (S308). The software timer measures a predetermined time period. The software circuit 251 decides, with reference to the software timer, whether a dialed digit is to be stored in the storage circuit 252 or not. If the storage circuit 252 receives the next digit before the predetermined time period has passed, then the controller circuit 251 stops the software timer (S318).

When the user finishes dialing whole of the designation telephone number, the user does not have to dial any more. Therefore, after the last digit is dialed, the predetermined time period would have passed. As a result, if the software timer finishes measuring the predetermined time period (S310), then the storage circuit 252 stores whole of the designation telephone number, and informs the controller circuit 251 that the last digit has been received.

In response to the information, the controller circuit 251 ignores subsequent input from the dial pad 223, reads the designation telephone number from the storage circuit 252 ($311), and counts the number of digits of the designation telephone number ($312). In this case, the designation telephone number is “08-555-6666”. Consequently, the number of digits of the designation telephone number is nine.

The designation telephone number “08-555-6666” includes on the top of the telephone number the access code “0”, which indicates that this call is addressed to another area. With reference to the top digit “0”, the controller circuit 251 recognizes that the call is addressed to another area ($316), and then sends the designation telephone number to the DP/PB signal generating circuit 222 (S314).

The DP/PB signal generating circuit 222 sequentially transforms each digit of the designation telephone number “08-555-6666” to a DP/PB signal and outputs to the communication circuit 221. In response to this, the communication circuit 221 sends the DP/PB signals via the subscriber line 211 to the exchange 200 (S315).

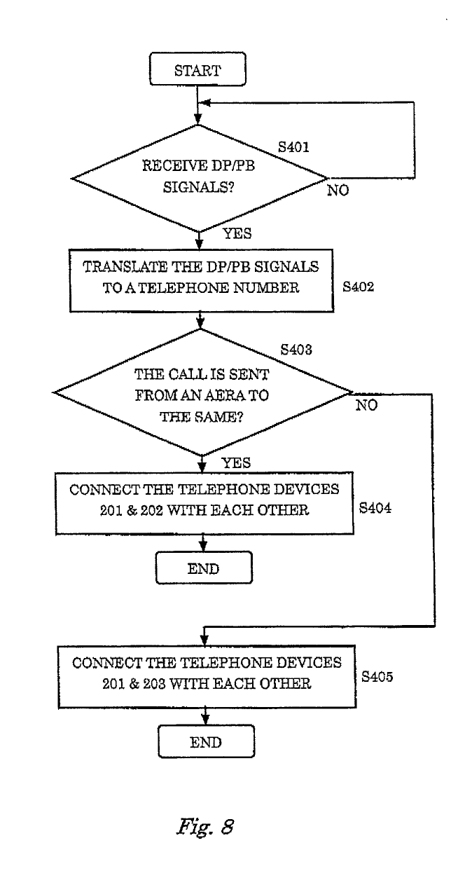

Turning to the FIG. 8, when the exchange 200 receives the DP/PB signals from the telephone device 201 (S401), the exchange 200 transforms the DP/PB signals to the designation telephone number “08555-6666” (S402). With reference to the top two digits “08” of the designation telephone number, the exchange 200 recognizes that the call is addressed to the area LA2, whose area code is “08” (S403). Finally, the exchange 200 connects the telephone device 201 in the area LA1, which is assigned to the area code “07”, to the telephone device 203 in the area LA2, which is assigned to the area code “08” (S405).

(B) Calling From an Area to the Same Area

It is assumed that the designation telephone number is “07-333-4444”. In this case (B), a call is sent from the area LA1 to the same area LA2.

Turning again to FIG. 6 and 7, first, the user of the telephone device 201 dials the designation telephone number “333-4444” with the dial pad 223 (S305). The telephone device 202 is in the same area as the telephone device 201. Therefore, the user would dial the designation telephone number except the area code “07”.

The dial pad 223 sequentially outputs each digit of the designation telephone number “333-4444” to the storage circuit 252 (S306). The storage circuit 252 stores the digits and sequentially informs the controller circuit 251 that the storage circuit 252 receives a digit (S307). Each time the controller circuit 251 receives the information, the controller circuit 251 activates the software timer (S308).

If the storage circuit 252 receives the next digit from the dial pad 223 before the predetermined time period has passed (S309), then the controller circuit 252 resets the software timer (S318). After the user has dialed the last digit of the designation telephone number, the user would not dial any more. If the predetermined time period has passed without being dialed a new digit, then the storage circuit 252 stores the last digit and informs that the storage circuit 252 receives one digit.

In response to the information, the controller circuit 251 inactivates the software timer in order to reject additional digits from the dial pad 223 (S310). The controller circuit 251 then reads the designation telephone number from the storage circuit 252 (SS11) and counts the number of digits of the designation telephone number (S312).

The storage circuit 252 now stores the designation telephone number “333-4444”. With reference to the stored telephone number, the controller circuit 251 acquires that: the stored number does not include on its top the access code “0”, which indicates that the call is addressed to another area (S316); and the number of digits of the stored number corresponds to the number of digits of a telephone number except the area code of the area LA1 (S317).

Based on the acquirement, the controller circuit 251 recognizes that the call is addressed to the same area the user has dialed from. Then, the controller circuit 251 adds the access code “0”, which indicates that the call is addressed a different area, and the area code “7”, which indicates that the call is addressed to the area LA1, to the dialed telephone number “333-4444” (S318). As a result, the controller circuit 251 generates whole of the designation telephone number “07-333-4444”. After that, the controller circuit 251 outputs the designation telephone number “07-333-4444” to the DP/PB signal generating circuit 222 (S314).

The DP/PB signal generating circuit 222 sequentially transforms each digit of the designation telephone number “07-333-4444” to a DP or PS signal and sends the signal to the communication circuit 221. The communication circuit 221 sends the signals via the subscriber line 211 to the exchange 200 (S315).

Turning again to FIG. 8, the exchange 200 translates the signals sent from the telephone device 201 to the designation telephone number “07-333-4444” (S402). According to the designation telephone number, the exchange 200 recognizes that the call is addressed to the telephone device 202 in the area LA1.

According to the location of the telephone device 201, the exchange 200 recognizes that the telephone device 201, with which the user dialed the call, belongs to the area LA1 (S403). The exchange 200 further recognizes that the call will connect the telephone devices 201 and 203, both of that belong to the same area LA1, with each other as a local call or a city call (S403).

Based on the above-mentioned recognition, the exchange 200 connects the telephone devices 201 and 202, both of that belong to the same area LA1 of the area code “07”, with each other (S404).

(C) Calling to Authorized Parties

It is assumed that the designation telephone number is one of an authorized party. The telephone number authorized party is for example an emergency police telephone number, an emergency firehouse telephone number or an emergency medical telephone number. These telephone numbers are usually composed of three digits. Telephone numbers of authorized parties is called as “authorized telephone number”.

Turning again to FIG. 6 and 7, as mentioned above, if the user has dialed a telephone number, the controller circuit 251 reads the telephone number from the storage circuit 252 (S311) and counts the number of digits of the telephone number (S312).

According to the number of digits, the controller circuit 251 recognizes that the call is addressed to an authorized party (S313), and sequentially sends each digit of the authorized telephone number to the DP/PB signal generating circuit 222 (S314). The DP/PB signal generating circuit 222 transforms each of the digits to a DP/PB signal sequentially and outputs the signals to the communication circuit 221. The communication circuit 221 sends the signals via the subscriber line 211 to the exchange 200 (S315).

(D) Receiving a Call with a Telephone Device

This receiving operation is applicable to the telephone devices 201, 202 and 203. The following description takes up the telephone device 201 as an example.

Turning again to FIG. 6 and 7, when the exchange 200 informs the telephone device 201 of receiving a call (S301), the ringer circuit 232 makes the electric bell 232 ring in order to inform the user of receiving the call.

In response to the ringing, if the user hooks off the handset 223 (S302), then the user starts talking to the caller (S303). On the other hand, if the user leaves the handset 223 hooked on, the ringer circuit 232 keeps the electric bell 232 ringing until the caller hooks on her/his handset.

As mentioned above, according to the present invention, the telephone device stores a dialed telephone number and analyzes it to identify the call as a call to the same area or to another area. If the telephone number is identified as one to the same area, then the telephone device adds the area code of the telephone device itself to the dialed telephone number and sends it to the exchange.

On the other hand, no modification or remodeling is required to the exchange even if the exchange accommodates plural areas. Conventional software for exchanging operation is applicable to the exchange connected with the telephone device. The exchange does not require additional memory capacity. It is unnecessary to change data of subscribers that the exchange accommodates and to change numbering plan of telephone numbers in the areas that the exchange accommodates.

While this invention has thus far been described in conjunction with a few embodiments thereof, it will be readily possible for those skilled in the art to put the this invention into various other manners.

For example, between STEPS S313 and S314, the controller circuit 251 may add the area code of the area, to which the telephone device 201 belongs, to the authorized telephone number and send it to the DP/PB signal generating circuit 222. In this case, if the user has dialed an authorized telephone number, then the area code of the user's telephone number and the authorized telephone number are sent to the exchange 200. Therefore, with reference to the area code, the exchange 200 can connect the call to the reception center of the authorized party in the same area. Particularly, it is required that an emergency call is connected to a nearby reception center since the authorized party must respond with the emergency call as soon as possible.

What is claimed is:

1. A telephone device which is assigned to a caller telephone number, the caller telephone number comprising a caller area code, wherein the telephone device comprises:
an input device for accepting a first telephone number;
a storage device for storing the first telephone number;
a controller circuit for judging whether the first telephone number stored in the storage device designates one of the telephone numbers grouped by the caller area code or not, and for adding the caller area code to the top of the first telephone number to generate a second telephone number when the first telephone number designates one of the telephone numbers grouped by the caller area code; and
a signal generator circuit for generating a signal for transmitting the second telephone number to an exchange.

2. The telephone device claimed in claim 1, wherein the controller circuit:
counts the number of digits of the first telephone number stored in the storage device;
judges whether the first telephone number is one of predetermined telephone numbers or not, according to the counted number; and
outputs the first telephone number to the signal generator circuit when the first telephone number is one of the predetermined telephone numbers.

3. The telephone device claimed in claim 1, wherein the controller circuit:
judges whether the first telephone number stored in the storage device is one of predetermined telephone numbers or not, according to at least one top digit of the first telephone number; and
outputs the first telephone number to the signal generator circuit when the first telephone number is one of the predetermined telephone numbers.

4. The telephone device claimed in claim 1, wherein the controller circuit:
activates a timer when one digit is input from the storage device;
judges whether the first telephone number stored in the storage device designates one of the telephone numbers grouped by the caller area code when the timer has clocked a predetermined time period before the next digit of the first telephone number is input from the storage device; and
adds the caller area code to the top of the first telephone number to generate a second telephone number when the first telephone number designates one of the telephone numbers grouped by the caller area code.

5. The telephone device claimed in claim 1, wherein the controller circuit:
counts the number of digits of the first telephone number stored in the storage device;
judges whether the first telephone number is one of predetermined telephone numbers or not, according to the counted number;
adds the caller area code to the top of the first telephone number to generate a second telephone number when the first telephone number is one of the predetermined telephone numbers; and
outputs the second telephone number to the signal generator circuit .

6. A method of exchanging a call from a telephone device which belongs to an area assigned to a caller area code, comprising the steps of:
inputting a first telephone number to the telephone device;
storing whole of the first telephone number in the telephone device;
judging whether the first telephone number includes the caller area code or not;
adding the caller area code to the top of the first telephone number in order to generate a second telephone number according to the result of the judging step; and
sending the second telephone number to an exchange.

7. The method claimed in claim 6, further comprising the steps of:
counting the number of digits of the first telephone number stored at the storing step;
judging whether the first telephone number is one of predetermined telephone numbers or not, according to the result of the counting step; and
sending the first telephone number to the exchange, if the first telephone number is one of the predetermined telephone numbers.

8. The method claimed in claim 6, further comprising the steps of:
counting the number of digits of the first telephone number stored at the storing step;
judging whether the first telephone number is one of predetermined telephone numbers or not, according to the result of the counting step; and
adding the caller area code to the top of the first telephone number in order to generate a second telephone number according to the result of the judging step; and
sending the second telephone number to the exchange.
